(19) United States
(12) Patent Application Publication
(10) Pub. No.: US 2013/0134195 A1
(43) Pub. Date: May 30, 2013

(54) Handled tool holder

(71) Applicants: Kerry Liddle, Oak Grove, MN (US); Janette Liddle, Oak Grove, MN (US)

(72) Inventors: Kerry Liddle, Oak Grove, MN (US); Janette Liddle, Oak Grove, MN (US)

(21) Appl. No.: 13/373,786

(22) Filed: Nov. 30, 2011

(51) Int. Cl. B60R 9/06; B60R 9/00; B60R 7/00

(52) U.S. Cl. 224/404; 224/542; 224/402; 224/401

(57) ABSTRACT

A device for storing handled tools in a vehicle, formed from a three dimensional body sized to fit in a vehicle and having a vertical dimension defining a vertical wall. The body includes at least one tube extending from the vertical wall of the body through at least a portion of the body, the at least one tube being sized to accommodate a handled tool. The body has a top surface on the body having sufficient strength to support cargo carried in the vehicle.

### FIELD OF THE INVENTION

The present invention relates to an improved device for holding and storing tools with handles, like rakes, shovels and the like. More particularly, the invention relates to a device for use with a truck or other vehicle having an open bed or a closed storage room to secure the tools.

### BACKGROUND OF THE INVENTION

People who drive trucks and other open bed vehicles often carry tools and other equipment in the open bed. When the tools are just left to lie in the bed, they may slide or bounce as the vehicle is driven, particularly over uneven terrain. The risk is that the tools will be damaged or broken, or that they will damage or break other cargo.

U.S. Pat. No. 4,733,898 describes a bed or floor that has small tool bins and is essentially a two level floor where tools and other objects can be slid between the two levels. When handled tools are put in the long drawer, for example, they will bounce and bump into each other when driven over rough terrain.

In some instances, brackets are used to hold the tools. U.S. Pat. No. 3,893,568 shows tools mounted on the side of the pickup bed using U-shaped brackets that the tools sit in. Although they are placed over the wheel wells, they do reduce the available space in the truck bed.

U.S. Pat. No. 45,498,048 has a storage product for tools. Others use tool boxes that take up some of the space of the open bed. Trays with racks also take up space and make it difficult if not impossible to use the space for carrying items.

It would be of advantage in the art if a tool holder could be provided that allowed full use of the open space in the vehicle bed while safely storing the tools.

A particular advantage would be if tools that have handles could be carried and stored in the open bed of a vehicle while leaving the open space free for other uses such as carrying cargo.

It would be another advance in the art if such a tool holder could allow access to the tools without having to move or remove other tools, thus permitting the user to select only the tools needed at that time.

Other advantages will appear hereinafter.

### SUMMARY OF THE INVENTION

It has now been discovered that the above and other advantages of the present invention may be obtained in the following manner. Specifically, the present invention provides a holder for tools and other objects that have handles, such as rakes, shovels, brooms, axes, suction pipes, saws, and the like.

The device may be used with any type of open vehicle. Examples include pickup trucks, cargo vans, cube vans, flat bed trucks, communication vehicles, fire prevention vehicles and others. The device is placed on the floor or may be secured to a side wall.

The handled tool holder device of this invention comprises a three-dimensional structure that is normally rectangular in shape, though it could have other shapes. For pickup trucks, the rectangle would be sized to fit in the truck bed. The vertical direction would range from less than six inches to more than one foot. In the vertical side facing to the back of the vehicle, tubes are provided so that handled tools can be inserting handle end first into a tube. Preferably the tubes would slant down as they extended toward the front of the vehicle but can be parallel to the ground if desired. A slight slant would insure the tools would stay in the tube until withdrawn. A tailgate would serve the same function. Tube diameters can range from less than about an inch to more than three inches. Two inch diameter tubes have been found to be effective.

### BRIEF DESCRIPTION OF THE DRAWINGS

For a more complete understanding of the invention, reference is hereby made to the drawings, wherein like numbers refer to like elements, and in which:

FIG. 1 is a top view of one embodiment of the present invention.

FIG. 2 is a perspective view of a second embodiment of the present invention.

FIG. 3 is a perspective view of the present invention showing another embodiment.

### DETAILED DESCRIPTION OF THE PREFERRED EMBODIMENT

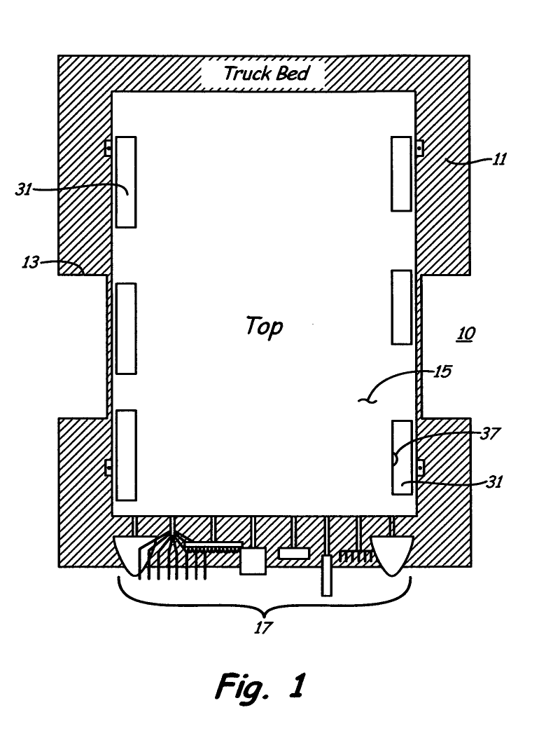

As shown in FIG. 1, the device of this invention, 10 generally, is positioned in a truck bed 11, allowing space for the wheel wells 13. While truck bed 11 is shown as a pickup truck bed, the vehicle may be any vehicle that has a floor or sides used to carry tools, such as pickup trucks, cargo vans, cube vans, flat bed trucks, communication vehicles, fire prevention vehicles and the like. The top 15 of device 10 is strong enough to support whatever weight is placed on it, either by one or more persons walking on top 15, or by cargo. A plurality of handled tools 17 are shown in device 10. Tools having handles are, for example and not by way of limitation, rakes, shovels, brooms, axes, suction pipes, saws, and the like.

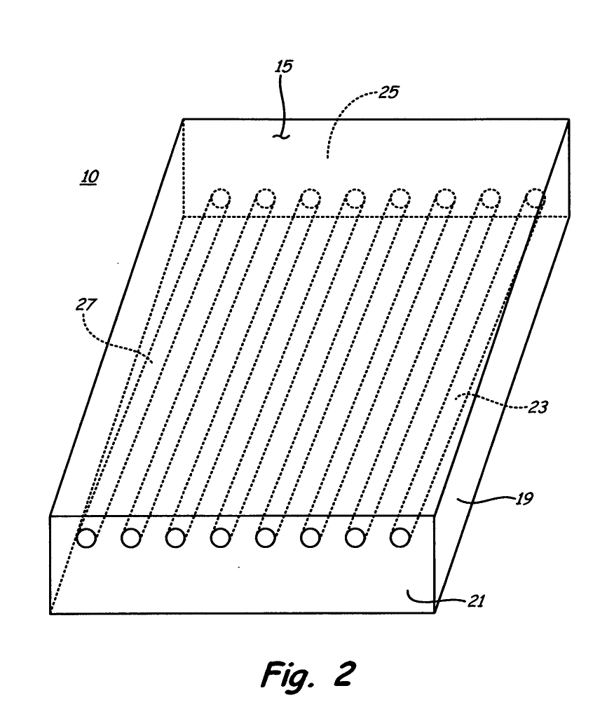

FIG. 2 shows one embodiment of the device, 20, that is made from a solid material such as a hard plastic or polyurethane. Device 10 can be molded or cast. It should be strong enough to support the same general use that the vehicle is intended to support. The device 10 in FIG. 2 has sides 19 and a front end 21. A plurality of tubes 23 are formed in device 20 and extend back as far as desired, even to back end 25. In one embodiment, not shown, tubes 23 may alternatively be parallel to top 15 and in a preferred alternate embodiment the tubes 23 and 27 are tapered or slanted in a downward angle so that the far ends of tubes 23 and 27 are lower on back end 25 than on the front end 21. This provides additional gravity forces to keep the handles of tools 17 in the tubes 23 and 27. Tube diameters can range from less than about an inch to more than three inches. Two inch diameter tubes have been found to be effective.

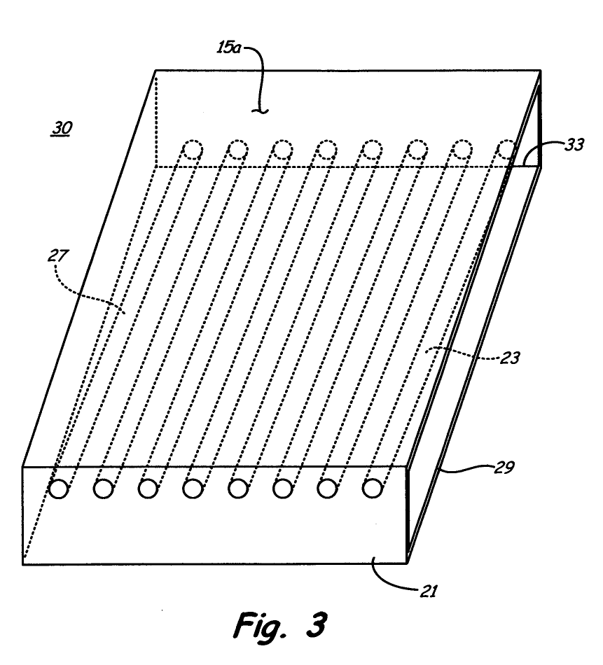

FIG. 3 illustrates an alternative embodiment where device 30 is has top 15a but is made of a frame formed by side frame 29, front end frame 21 and back end frame 33. Additional supports, not shown, may be added to insure top 15a does hold sufficient weight for normal use. Front end frame 21 has holes for mounting tubes 23 that are parallel to top 15 and holes that permit sloped or tapered tubes 23 and 27 extending to the back end frame 33.

Also shown in FIG. 1 are a plurality of tool boxes 31 with lids that open, permitting additional storage of tools, gloves and other objects. Tool boxes 31 may have a handle or recess 37 to facilitate gaining access to the inside.

The present invention provides for additional on road safety. By holding and securing handled tools from falling out of existing open end vehicles, transportation on state, county or city roads, accidents and bodily injury to the general public is avoided.

While particular embodiments of the present invention have been illustrated and described, it is not intended to limit the invention, except as defined by the following claims.

1. A device for storing handled tools and other object in a vehicle, comprising:
a three dimensional body sized to fit in a vehicle and having a vertical dimension defining a vertical wall;
at least one tube extending from the vertical wall of the body through at least a portion of the body, the at least one tube being sized to accommodate a handled tool; and
a top surface on the body having sufficient strength to support cargo carried in the vehicle.

2. The device of claim 1, wherein the device includes a plurality of tubes.

3. The device of claim 1, wherein the at least one tube linearly extends from proximate the top surface downward.

4. The device of claim 1, wherein the three dimensional body is rectangular in shape.

5. The device of claim 1, wherein the three dimensional body is solid and the at least one tube is formed in the solid portion of the body.

6. The device of claim 5, wherein the solid body is formed from plastic.

7. The device of claim 1, wherein the three dimensional body is at least partially hollow and the at least one tube is fixedly mounted in the hollow body.

8. The device of claim 7, wherein the at least partially hollow body is formed from a material selected from the group consisting of metal, fiberglass and plastic.

9. The device of claim 1, which further includes at least one cavity in the top surface for storing objects, the cavity including a lid for enclosing the cavity.

10. The device of claim 9, wherein the at least one cavity includes a recessed handle for opening the cavity lid.

11. The device of claim 1 wherein the tool is selected from the group consisting of rakes, shovels, brooms, axes, suction pipes, saws, and the like.

12. The device of claim 1, wherein the vehicle is selected from the group consisting of pickup trucks, cargo vans, cube vans, flat bed trucks, communication vehicles, and fire prevention vehicles.

13. The device of claim 12, wherein the device is placed on the floor or secured to a side wall.

14. A device for storing handled tools and other object in a vehicle, comprising:
a three dimensional body sized to fit in a vehicle and having a vertical dimension defining a vertical wall;
a plurality of tubes extending from the vertical wall of the body through at least a portion of the body, the plurality of tubes being sized to accommodate a handled tool such that each tube linearly extends from proximate the top surface downward; and
a top surface on the body having sufficient strength to support cargo carried in the vehicle.

15. The device of claim 14, wherein the three dimensional body is rectangular in shape.

16. The device of claim 14, wherein the three dimensional body is solid and the at least one tube is formed in the solid portion of the body.

17. The device of claim 14, wherein the three dimensional body is at least partially hollow and the at least one tube is fixedly mounted in the hollow body.

18. The device of claim 14, which further includes at least one cavity in the top surface for storing objects, the cavity including a lid for enclosing the cavity and wherein the at least one cavity includes a recessed handle for opening the cavity lid.

19. A device for storing handled tools and other object in a vehicle, comprising:
a three dimensional body sized to fit on the floor in a vehicle selecting from the group consisting of pickup trucks, cargo vans, cube vans, flat bed trucks, communication vehicles, and fire prevention vehicles ,and the body has a vertical dimension defining a vertical wall;
a plurality of tubes extending from the vertical wall of the body through at least a portion of the body, the plurality of tubes being sized to accommodate a handled tool such that each tube linearly extends from proximate the top surface downward; and
a top surface on the body having sufficient strength to support cargo carried in the vehicle with at least one cavity in the top surface for storing objects, the cavity including a lid for enclosing the cavity and wherein the at least one cavity includes a recessed handle for opening the cavity lid.

20. The device of claim 19, wherein the tool is selected from the group consisting of rakes, shovels, brooms, axes, suction pipes, saws, and the like.
